(19) United States
(12) Patent Application Publication
(10) Pub. No.: US 2014/0179242 A1
(43) Pub. Date: Jun. 26, 2014

(54) WATCH AND NFC ANTENNA THEREOF

(71) Applicant: HON HAI PRECISION INDUSTRY CO., LTD., New Taipei (TW)

(72) Inventor: KUANG-YAO LIAO, New Taipei (TW)

(73) Assignee: HON HAI PRECISION INDUSTRY CO., LTD., New Taipei (TW)

(21) Appl. No.: 13/873,236

(22) Filed: Apr. 30, 2013

(30) Foreign Application Priority Data
Dec. 21, 2012 (TW) 101148904

(51) Int. Cl. H04W 4/00

(52) U.S. Cl. CPC H04W 4/008
USPC 455/90.1

(57) ABSTRACT

A near field communication (NFC) antenna for mounting on a watch. The watch includes a display screen. The NFC antenna includes a printed circuit board (PCB) for disposed on the display screen of the watch, a number of concentrically wound coils disposed on a surface of the PCB and a shielding layer disposed on an opposite surface of the PCB to the coils. The shielding layer is sandwiched between the display screen and the surface of the PCB, spatially corresponding to the coils. A related watch is also provided.

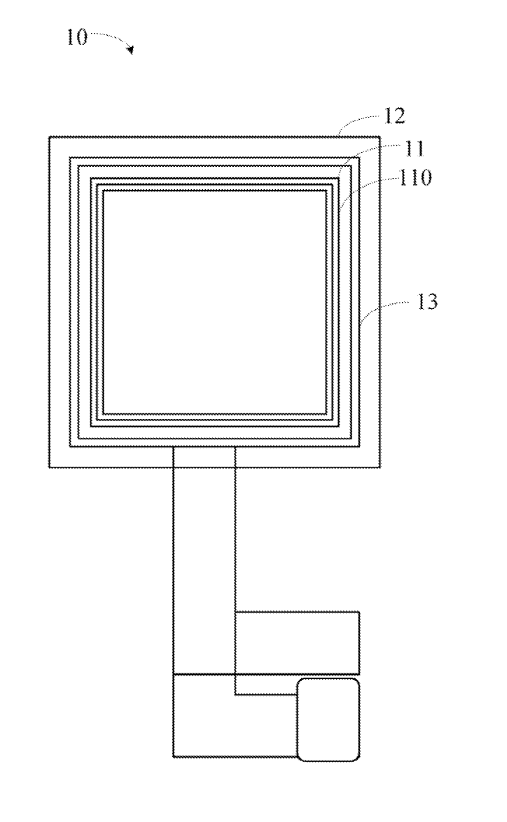

### BACKGROUND

1. Technical Field

The present disclosure relates to antennas and watches having the antennas and particularly to a watch and near field communication antenna thereof.

2. Description of the Related Art

Nowadays, watches having near field communication (NFC) antennas are very popular. However, the NFC antennas employed in the watches occupy a lot of space. Furthermore, electrical elements disposed on a PCB of the watch may cause electrostatic interference with the NFC antenna.

Therefore, there is room for improvement within the art.

### BRIEF DESCRIPTION OF THE DRAWINGS

The components in the drawing are not necessarily drawn to scale, the emphasis instead being placed upon clearly illustrating the principles of the disclosure. Moreover, in the drawing, like reference numerals designate corresponding parts throughout the view.

The FIGURE is a schematic plan view of a NFC antenna of a watch, in accordance with an exemplary embodiment.

### DETAILED DESCRIPTION

Referring to the FIGURE, a watch 10 includes a near field communication (NFC) antenna 11, a display screen 12, and a printed circuit board (PCB) 13. The NFC antenna 11 includes a plurality of concentrically wound coils 110 with coil sizes changing gradually. In the embodiment, each of the plurality of coils 110 is rectangular. In an alternative embodiment, each of the plurality of coils 110 is circular. The display screen 12 is configured to display time, date, and so on.

The NFC antenna 11 is disposed on a surface of the PCB 13. In the embodiment, the PCB 13 is a flexible printed circuit (FPC). An antenna shielding layer (not shown) is disposed on the opposite surface of the PCB 13. The PCB 13 is pasted on a surface of the display screen 12. The shielding layer is sandwiched between the display screen 12 and the PCB 13, which shields the NFC antenna 11 from electrical elements (not shown) disposed on the PCB 13, resulting in reduced electrostatic interference therebetween.

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. A near field communication (NFC) antenna for mounting on a watch, the watch including a display screen, the NFC antenna comprising:
a printed circuit board (PCB) for disposed on the display screen of the watch;
a plurality of concentrically wound coils disposed on a surface of the PCB; and
a shielding layer disposed on an opposite surface of the PCB to the coils, the shielding layer configured for being sandwiched between the display screen and the surface of the PCB, spatially corresponding to the coils.

2. The NFC antenna as recited in claim 1, wherein each of the plurality of coils is rectangular.

3. A watch, comprising:
a display screen;
an NFC antenna, comprising:
a PCB disposed on the display screen;
a plurality of concentrically wound coils disposed on a surface of the PCB; and
a shielding layer disposed on an opposite surface of the PCB to the coils, the shielding layer being sandwiched between the display screen and the PCB, spatially corresponding to the coils.

4. The watch having an NFC antenna as recited in claim 3, wherein each of the plurality of coils is rectangular.
